(19) United States
(12) Patent Application Publication
(10) Pub. No.: US 2013/0322087 A1
(43) Pub. Date: Dec. 5, 2013

(54) WATERPROOF FAIRY LIGHT

(71) Applicant: Wei-Jen TSENG, Hsinchu City (TW)

(72) Inventor: Wei-Jen TSENG, Hsinchu City (TW)

(21) Appl. No.: 13/482,899

(22) Filed: May 29, 2012

(51) Int. Cl. F21V 31/00; F21V 17/10; F21V 5/04

(52) U.S. Cl. 362/311.02; 362/368

(57) ABSTRACT

A waterproof fairy light has a housing, a socket and a lighting assembly. The housing has an assembling hole defined therein. The socket is mounted in the assembling hole and has a cavity defined through the socket and having an inner surface and a partition formed in the cavity on the inner surface, dividing the cavity into two spaces and having two opposite side edges formed integrally on the inner surface of the cavity so that no gap is formed between each side edge and the inner surface. The lighting assembly is mounted in the cavity of the socket and has a lighting element and two contacting pins. The integrally formed partition prevents rain from contacting both the contacting pins and causing short circuit.

### BACKGROUND OF THE INVENTION

1. Field of the Invention

The present invention relates to a light, and more particularly to a waterproof fairy light that effectively prevents conductive objects such as water from contacting both the contacting pins so that short circuit of the waterproof fairy light will not be incurred.

2. Description of Related Art

Conventional decorative fairy lights mainly employ a light-emitting diode (LED) as a lighting element. A decorative fairy light has a casing, a socket, an LED, two wires and a partition. The casing is hollow and tubular and has a top opening. The socket is mounted in the top opening and has a socket hole. The LED is mounted in the socket hole at a top end of the socket and has two contacts extending out of a bottom end of the socket. The wires extend into the casing from a bottom end and are electrically connected respectively to the contacts of the LED so that electrical power is supplied to the LED through the wires. The partition is mounted in the socket hole between the wires and physically and electrically isolates the contacts of the LED to prevent problems of short circuit.

However, the partition is a separate and independent element from the socket and is mounted in the socket by assembling methods such that tiny gaps exist between each side of the partition and an inner surface of the socket hole. When the decorative fairy light is set outdoors and suffers moisture or rain, water enters into the socket hole and passes through the gaps between the inner surface of the socket hole and the partitions, and contacts both the contacts and/or wires to cause short circuit and breakdown of the decorative fairy light. Because decorative fairy lights are connected generally in series and assembled into a light string, when one of the decorative fairy lights is damaged, the rest of the decorative fairy lights are also snuffed off.

To overcome the shortcomings, the present invention provides a waterproof fairy light to mitigate or obviate the aforementioned problems.

### SUMMARY OF THE INVENTION

The main objective of the invention is to provide a waterproof fairy light that effectively prevents conductive objects such as water from contacting both the contacting pins so that short circuit of the waterproof fairy light will not be incurred.

A waterproof fairy light in accordance with the present invention has a housing, a socket and a lighting assembly. The housing has an assembling hole defined therein. The socket is mounted in the assembling hole and has a cavity defined through the socket and having an inner surface and a partition formed in the cavity on the inner surface, dividing the cavity into two spaces and having two opposite side edges formed integrally on the inner surface of the cavity so that no gap is formed between each side edge and the inner surface. The lighting assembly is mounted in the cavity of the socket and has a lighting element and two contacting pins. The integrally formed partition prevents rain from contacting both the contacting pins and causing short circuit.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a waterproof fairy light in accordance with the present invention;

FIG. 2 is an exploded perspective view of a lighting assembly and a socket of the waterproof fairy light in FIG. 1;

FIG. 3 is a partially exploded perspective view of the waterproof fairy light in FIG. 1;

FIG. 4 is a cross sectional side view of the waterproof fairy light in FIG. 1;

FIG. 5 is a cross sectional top view of the waterproof fairy light in FIG. 1;

FIG. 6 is a perspective view of a second embodiment of the waterproof fairy light in accordance with the present invention;

FIG. 7 is a partially exploded perspective view of the waterproof fairy light in FIG. 6;

FIG. 8 is an exploded perspective view of a socket, a lighting assembly and a lamp lens of the waterproof fairy light in FIG. 6;

FIG. 9 is a cross sectional side view of the waterproof fairy light in FIG. 6;

FIG. 10 is a cross sectional side view of a casing and the socket of the waterproof fairy light in FIG. 6; and

FIG. 11 is a cross sectional top view of the waterproof fairy light in FIG. 6.

### DETAILED DESCRIPTION OF THE PREFERRED EMBODIMENT

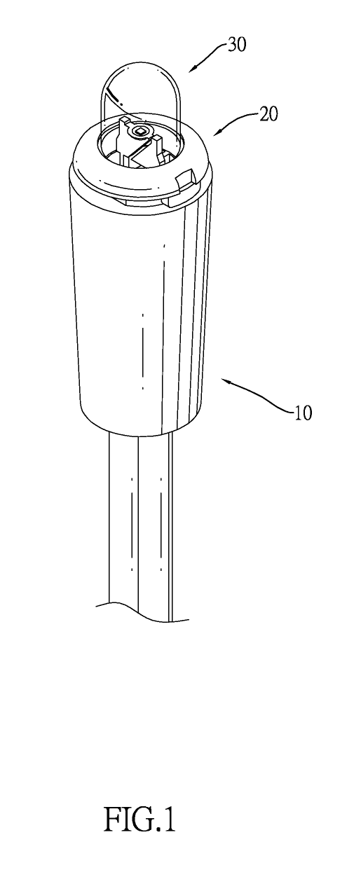

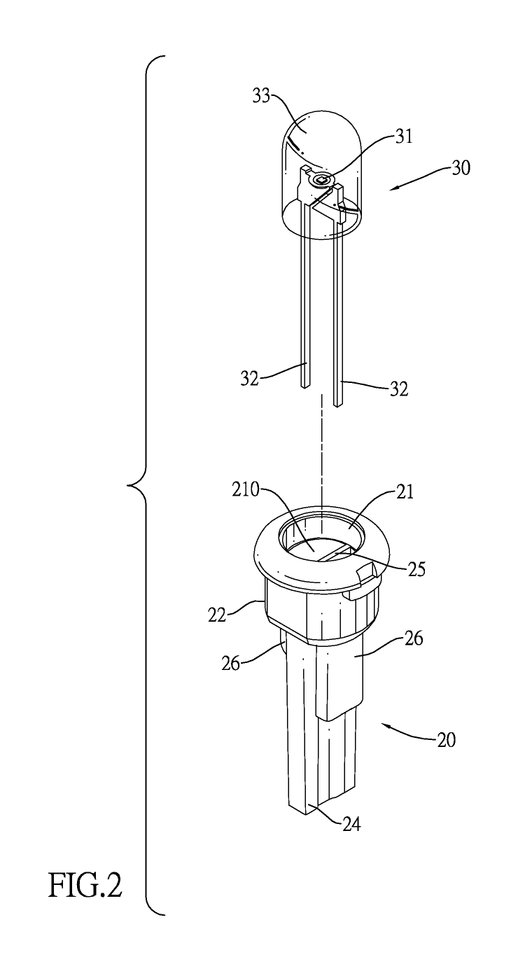

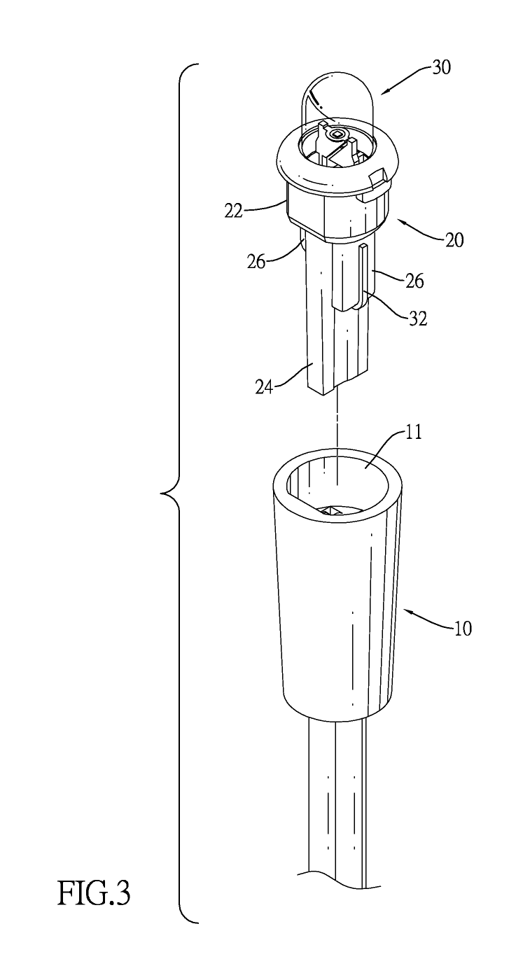

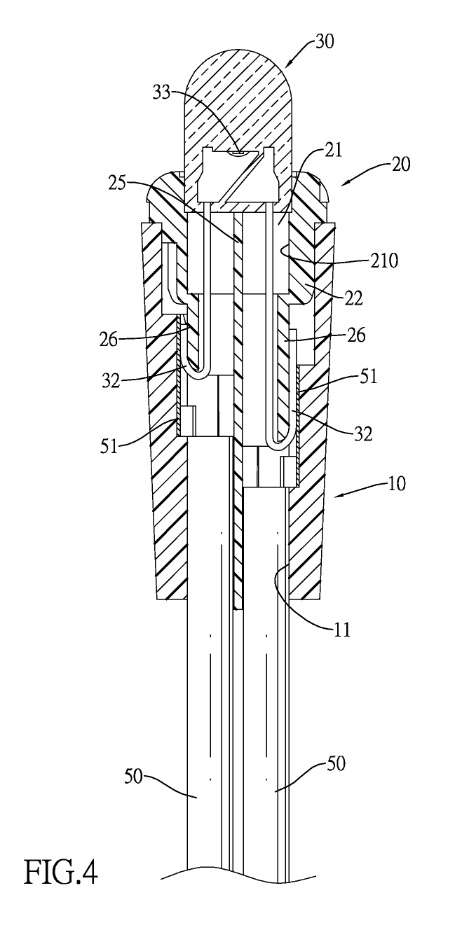

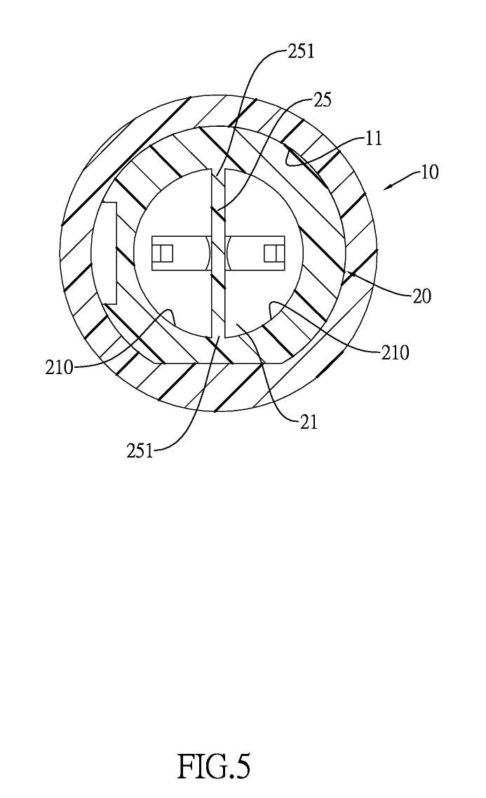

With reference to FIGS. 1 to 5, a waterproof fairy light in accordance with the present invention is connected to a pair of wires 50 and comprises a housing 10, a socket 20 and a lighting assembly 30.

The housing 10 is hollow and has a top end, a bottom end and an assembling hole 11 defined through the housing 10.

The socket 20 is mounted in the assembling hole 11 through the top end of the housing 10 and has a top, a bottom, a cavity 21 and a partition 25 and may further have a crown 22, an elongated segment 24 and two locking segments 26.

The cavity 21 is defined through the socket 20 and has an inner surface.

The partition 25 is formed on the inner surface in the cavity 21, divides the cavity into two spaces 210 and has two opposite side edges formed integrally on the inner surface of the cavity 21 so that no gap is formed between each side edge and the inner surface. The crown 22 is located at the top of the socket 20. The elongated segment 24 is formed on and protrudes downward from the crown 22 and has two opposite sidewalls. The locking segments 26 are formed respectively on the sidewalls of the elongated segment 24. The wires 50 extend in the assembling hole 11 through the bottom end and are located respectively outside the spaces 210. The lighting assembly 30 may be an LED assembly, is mounted in the cavity 21 of the socket 20 and has a lighting element 31 and two contacting pins 32 connected to the lighting element 31 and extending respectively into the spaces 210. The contacting pins 32 are bent into U-shapes to hook respectively on the locking segments 26 and respectively contact the wires 50.

The lighting element 31 may be an LED and further have a lens case 33 covering the LED.

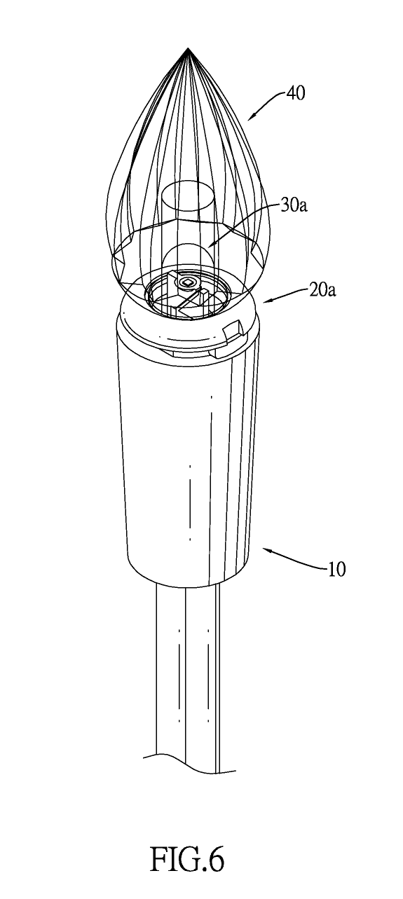

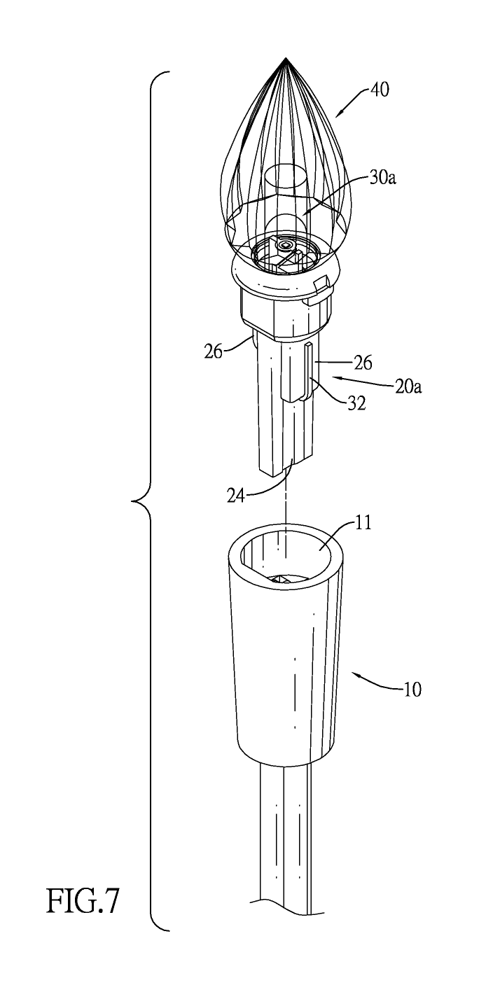

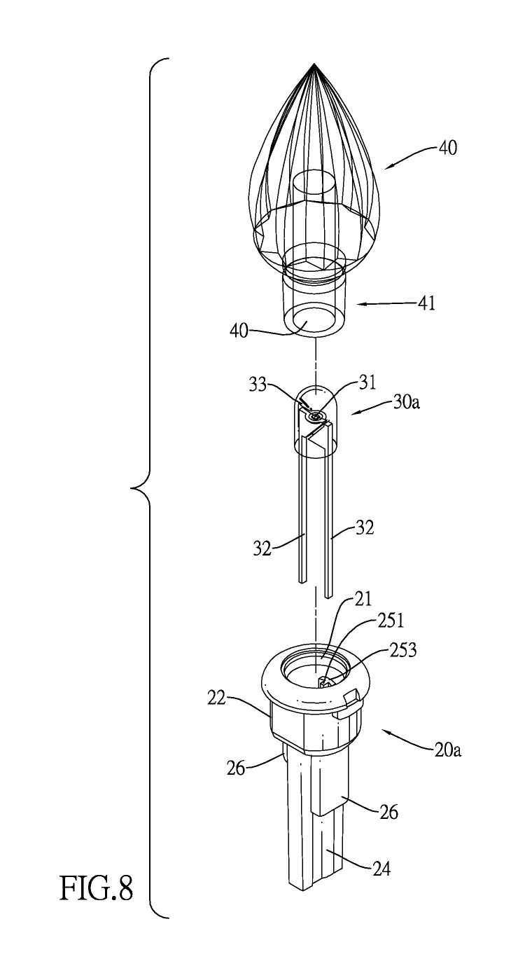

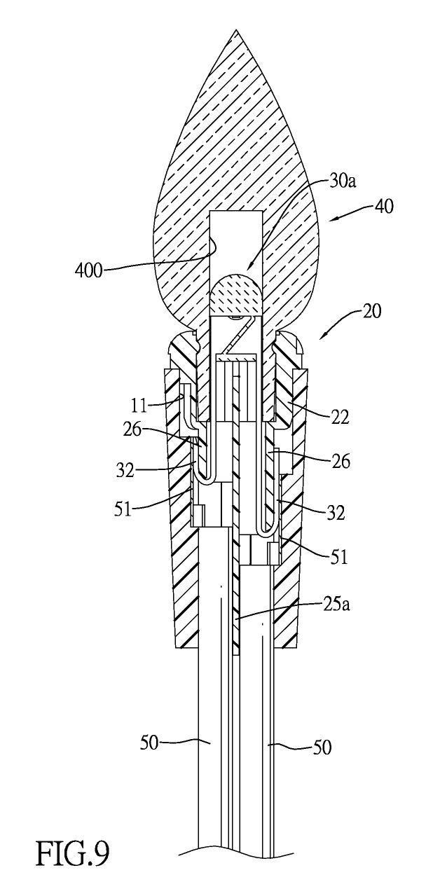

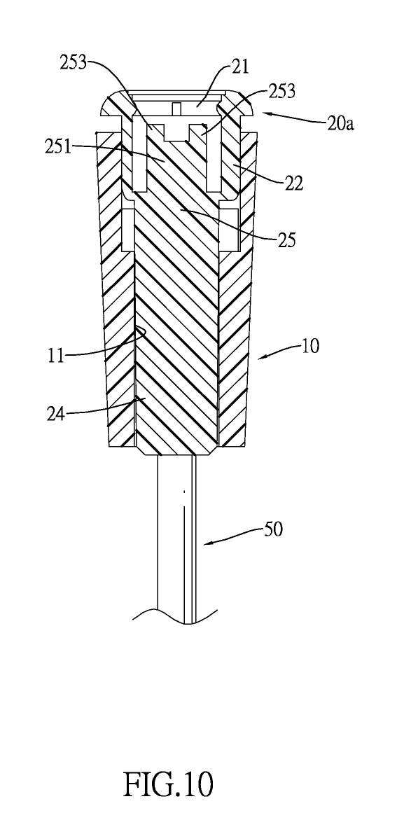

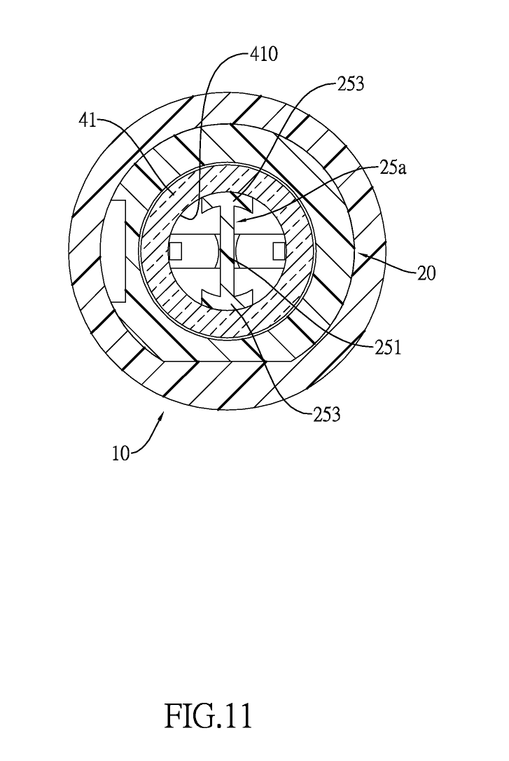

With further reference to FIGS. 6 to 11, a second embodiment of the waterproof fairy light in accordance with the present invention is similar to the first embodiment and also has a casing 10, a socket 20a and a lighting assembly 30a. However, the partition 25a of the second embodiment further has an extension tab 251. The extension tab 251 is formed on and protrudes upward from a top end of the partition 25a and has two opposite sides and two pressing tabs 253 formed respectively on and protruding transversely from the sides of the extension tab 251. Furthermore, each pressing tab 253 is arranged substantially perpendicular to the extension tab 251 to form a T-shape when the pressing tab 253 and extension tab 251 are viewed from a top view.

Moreover, the second embodiment further has a lamp lens 40. The lamp lens 40 may be transparent or translucent and is mounted on the socket 20a and has a bottom end, a mounting hole 400 and a sleeve 41. The mounting hole is defined in the bottom end and covers the extension tab 251. The sleeve 41 is formed on and protrudes downward from the bottom end of the lamp lens 40, surrounds the mounting hole 400 and has an inside surface tightly pressing against the pressing tabs 253 on the extension tab 251.

Because no gap is between the integrally formed partition 25, 25a on the socket 20, 20a and the inner surface of the cavity 21, rain or water entering the spaces 210 does not pass through the partition 25, 25a to contact both the contacting pins 32. Therefore, the integrally formed partition 25, 25a effectively prevents conductive fluid such as rain from passing therethrough and incurring problems of short circuit of the lighting assembly 30. Furthermore, the extension tab 251 and pressing tabs 253 of the second embodiment are able to tightly press against and fit into the sleeve 41 of the lamp lens 40 to further prohibit rain or dust from entering the lamp lens and causing the problems of short circuit.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A waterproof fairy light comprising:
a housing having a top end, a bottom and an assembling hole defined through the housing;
a socket mounted in the assembling hole through the top end of the housing and having:
a top;
a bottom;
a cavity defined through the socket and having an inner surface; and
a partition formed on the inner surface in the cavity, dividing the cavity into two spaces and having two opposite side edges formed integrally on the inner surface of the cavity so that no gap is formed between each side edge and the inner surface; and
a lighting assembly mounted in the cavity of the socket and having a lighting element and two contacting pins connected to the lighting element and extending respectively into the spaces.

2. The waterproof fairy light as claimed in claim 1, wherein the lighting assembly is an LED assembly and has a lens case covering the LED.

3. The waterproof fairy light as claimed in claim 1, wherein
the partition further has an extension tab formed on and protruding upward from a top end of the partition and having two opposite sides and two pressing tabs formed respectively on and protruding transversely from the sides of the extension tab;
a lamp lens is mounted on the socket and has
a bottom end;
a mounting hole defined in the bottom end and covering the extension tab;
a sleeve formed on and protruding downward from the bottom end of the lamp lens, surrounding the mounting hole and having an inside surface tightly pressing against the pressing tab on the extension tab.

4. The waterproof fairy light as claimed in claim 3, wherein each pressing tab is arranged substantially perpendicular to the extension tab to form a T-shape when the pressing tab and the extension tab are viewed from a top view.

5. The waterproof fairy light as claimed in claim 3, wherein the socket has
a crown located at the top of the socket;
an elongated segment formed on and protruding downward from the crown and having two opposite sidewalls; and
two locking segments formed respectively on the sidewalls of the elongated segment, wherein the contacting pins are bent into U-shapes to hook respectively on the locking segments.
